(19) United States
(12) Patent Application Publication
(10) Pub. No.: US 2021/0331463 A1
(43) Pub. Date: Oct. 28, 2021

(54) DROP DETECTOR CALIBRATION

(71) Applicant: HEWLETT-PACKARD DEVELOPMENT COMPANY, L.P., Spring, TX (US)

(72) Inventors: Erikk A. Ojala, Vancouver, WA (US); Miguel Alvarez, Vancouver, WA (US); Warren S. Martin, Vancouver, WA (US)

(21) Appl. No.: 16/607,753

(22) PCT Filed: Apr. 28, 2018
(86) PCT No.: PCT/US2018/030050

§ 371 Date: Oct. 24, 2019

(51) Int. Cl. B41J 2/045

(52) U.S. Cl. CPC B41J 2/0456; B41J 2/04586; B41J 2/04508

(57) ABSTRACT

A drop detector calibration system may include a fluid ejection bar, a drop detector movable along the fluid ejection bar at different spacings from the fluid ejection bar and a controller to determine a location of the fluid ejection bar based upon interaction between the fluid ejection bar and the drop detector during movement of the drop detector along the fluid ejection bar.

### BACKGROUND

Fluid ejection devices controllably eject drops of liquid. Such fluid ejection devices may be utilized in two-dimensional and three-dimensional printing systems. Drop detectors sense the ejection of drops by the fluid ejection devices to monitor fluid ejection performance and possibly address issues.

### BRIEF DESCRIPTION OF THE DRAWINGS

FIG. 1 is a schematic diagram of portions of an example drop detector calibration system.

FIG. 2 is schematic diagram of an individual fluid ejector or fluid ejection element during drop ejection monitoring by a drop detector.

FIG. 3 is a flow diagram of an example drop detector calibration method.

FIG. 4 is a schematic diagram of portions of an example drop detector calibration system in a first calibration state.

FIG. 5 is a schematic diagram of portions of the example drop detector calibration system of FIG. 4 in a second calibration state.

FIG. 6 is a schematic diagram of portions of an example drop detector calibration system in a first calibration state.

FIG. 7 is a schematic diagram of portions of the example drop detector calibration system of FIG. 6 in a second calibration state.

FIG. 8 is a flow diagram of an example drop detector calibration method.

FIG. 9 is a schematic diagram of portions of an example drop detector calibration system in a first calibration state.

FIG. 10 is a schematic diagram of portions of the example drop detector calibration system of FIG. 9 in a second calibration state.

FIG. 11 is a schematic diagram of portions of the example drop detector calibration system of FIG. 9 illustrating drop ejection monitoring of different portions of a fluid ejection bar.

FIG. 12 is a perspective view of an example fluid ejection system having an example drop detector calibration system.

FIG. 13 is a top perspective view of the fluid ejection system of FIG. 12 while omitting fluid ejection bars.

FIG. 14 is an enlarged fragmentary perspective view of portions of the fluid ejection system of FIG. 13 illustrating an example drop detector in greater detail.

FIG. 15 is a front sectional view of the fluid ejection system of FIG. 12.

FIG. 16 is an enlarged front view of portions of the fluid ejection system of FIG. 15 illustrating the drop detector calibration system in a first calibration state.

FIG. 17 is an enlarged front view of portions of the fluid ejection system of FIG. 15 illustrating the drop detector calibration system in a second calibration state.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example drop detector calibration systems and methods that facilitate calibration or control of a spacing between a drop detector and a fluid ejection bar to facilitate enhanced fluid ejection performance monitoring and adjustments. For purposes of this disclosure, a “fluid” refers to a liquid which may be output in the form of drops. The example drop detector calibration systems and methods may further provide enhanced control over the spacing between the drop detector and the fluid ejection bar with lower cost and a lesser degree of complexity.

Accurate and reliable drop ejection monitoring of a fluid ejection bar may be facilitated by precisely controlling the spacing between the drop detector and the fluid ejection bar. The actual positioning or location of a fluid ejection bar may vary from one system to another due to manufacturing variations and tolerances. The disclosed drop detector calibration systems identify the precise actual vertical location (Z-axis coordinate) of the fluid ejection bar with respect to a predefined coordinate system. The determined location of the fluid ejection bar facilitates enhanced control over the spacing between the drop detector and the fluid ejection bar during drop ejection monitoring.

Rather than lowering the fluid ejection bar into contact with the drop detector or raising the drop detector into contact with the fluid ejection bar to identify the actual location of the fluid ejection bar, the example drop detector calibration systems and methods rely upon interactions between the fluid ejection bar and the drop detector during movement of the drop detector along the fluid ejection bar to identify the vertical location (the vertical Z-axis coordinate) of the fluid ejection bar. Because the drop detector and the fluid ejection bar are not raised or lowered into contact with one another, enhanced control and resolution may be provided with respect to the vertical location, the Z-axis coordinate, at which the drop detector is positioned. This enhancement may be especially true with respect to systems where the drop detector is carried by a much larger servicing unit and wherein the much larger servicing unit is moved to move the drop detector towards and away from the fluid ejection bar.

At each vertical height, at each candidate Z-axis coordinate, the drop detector is moved along the fluid ejection bar (along the Y-axis) and its interaction or lack thereof with the fluid ejection bar is detected. The calibration system is dimensioned and supported such that a predefined interaction occurs when the drop detector that a predefined spacing relative to the particular position of the fluid ejection bar. Based upon the particular Z-axis coordinate of drop detector 28 at which a predefined interaction is detected, the calibration system determines the location of the fluid ejection bar in a predefined coordinate system. This location is subsequently utilized to control the spacing of the drop detector from the fluid ejection bar during drop ejection monitoring by the drop detector.

In one implementation, the fluid ejection bar is moved relative to the drop detector between each of the various candidate or test vertical heights or Z-axis coordinates at which the drop detector is moved along the fluid ejection bar to determine whether the predefined interaction occurs. In another implementation, the drop detector is moved relative to the fluid ejection bar between each of the various candidate Z-axis coordinates at which the drop detector is moved along the fluid ejection bar to determine whether the predefined interaction occurs. In one implementation, the drop detector is carried by or supported by a much larger fluid ejection bar servicing unit or station having a fluid absorbent web fluid ejection bar sealing or capping mechanisms and/or other fluid ejection bar servicing features, wherein the much larger fluid ejection bar servicing unit is moved relative to the fluid ejection bar to position the drop detector at each of the candidate or test Z-axis coordinates.

In one implementation, such interaction may be the direct physical contact between the drop detector and the fluid ejection bar. In such implementations, each of the drop detector and the fluid ejection bar may comprise horns, projections or structural probes that are dimension and supported so as to contact one another when the drop detector and the fluid ejection bar are at a predefined spacing from one another. The height or Z-axis coordinate at which such direct contact occurs and the known predefined spacing may then indicate the actual Z-axis location of the fluid ejection bar in the predefined coordinate space.

In one implementation, the drop detector is incrementally raised or moved towards the fluid ejection bar until the drop detector physically engages or contacts the fluid ejection bar during movement of the drop detector along the fluid ejection bar. The vertical height or Z-axis coordinate at which the drop detector initially contacts the fluid ejection bar may then be used to determine fluid ejection bar Z-axis location. For example, if the calibration system is designed such that initial contact or tip-to-tip contact occurs when a selected portion of the drop detector and the lower surface of the fluid ejection bar is spaced by a distance d along the z-axis, initial contact between the drop detector and the fluid ejection bar at a Z-axis coordinate value of r may then indicate that the lower surface of the fluid ejection bar is at coordinate of r+d along the Z-axis. If initial contact between the drop detector and the fluid ejection bar initially occurs at a Z-axis coordinate value of s, it may be determined that the lower surface of fluid ejection bar is that coordinate s+d. This determined Z-axis location may be subsequently utilized to position the selected portion of the drop detector relative to the lower surface of the fluid ejection bar during drop ejection monitoring by the drop detector.

In another implementation, the drop detector may be incrementally lowered or moved away from the fluid ejection bar until the drop detector initially passes or crosses the fluid ejection bar without contacting the fluid ejection bar. In such an implementation, spacing or height at which the drop detector initially crosses the fluid ejection bar may then be utilized to determine fluid ejection bar location in the predefined coordinate system. For example, if the calibration system is designed such that contact initially discontinues when a selected portion of the drop detector and the lower surface of the fluid ejection bar is spaced by a distance d along the z-axis, discontinuance of contact between the drop detector and the fluid ejection bar at a Z-axis coordinate value of r may then indicate that the lower surface of the fluid ejection bar is at coordinate of r+d along the z-axis. If the discontinuance of contact between the drop detector and the fluid ejection bar initially occurs at a z-axis coordinate value of s, it may be determined that the lower surface of fluid ejection bar is that coordinate s+d. Such determined location may be specifically utilized to position the selected portion of the drop detector relative to the lower surface of the fluid ejection bar during drop ejection monitoring by the drop detector.

In one implementation, such contact between the drop detector and the fluid ejection bar may be sensed by a sensor independent of an actuator utilized to translate the drop detector along the fluid ejection bar. In another implementation, such contact between the drop detector in the fluid ejection bar may be sensed based upon signals from the actuator utilized to translate the drop detector along the fluid ejection bar. For example, contact between the drop detector and the fluid ejection bar may result in stalling of movement of the fluid ejection bar. Such stalling may be detected. Contact between the drop detector and the fluid ejection bar may additionally or alternatively result in increased power consumption by the actuator, wherein the spike in power consumption is may indicate such contact or where a drop in power consumption indicates a discontinuance of such contact.

In yet other implementations, the determination that the drop detector is at a predefined spacing relative to the actual positioning of the fluid ejection bar may be indicated by indirect non-contact interaction between the drop detector in the fluid ejector. For example, in one implementation, one of the drop detector and the fluid ejection bar may comprise a light emitter-detector pair while the other of the drop detector in the fluid ejection bar comprises a projection or probe that interrupts a light beam between the emitter-detector pair when the drop detector is moved along the fluid ejection bar at a predefined spacing from the fluid ejection bar.

Disclosed herein is an example drop detector calibration system that may include a fluid ejection bar, a drop detector movable along the fluid ejection bar at different spacings from the fluid ejection bar and a controller to determine a location of the fluid ejection bar in a predefined coordinate system based upon interaction between the fluid ejection bar and the drop detector during movement of the drop detector along the fluid ejection bar.

Disclosed herein is an example method for calibrating a drop detector with respect to a fluid ejection bar. The method may include moving a drop detector to different Z-axis coordinates, moving the drop detector along the fluid ejection bar at each of the Z-axis coordinates and determining a location of the fluid ejection bar based upon a state of interaction between the drop detector and fluid ejection bar as the drop detector is moved along the fluid ejection bar.

Disclosed herein is a non-transitory computer-readable medium containing drop detector calibration instructions to direct a processing unit to: output signals to move a drop detector to different Z-axis coordinates of a coordinate system, output signals to move the drop detector along the fluid ejection bar at each of the coordinates and determine a location of the fluid ejection bar in the coordinate system based upon a state of interaction between the drop detector and fluid ejection bar as the drop detector is moved along the fluid ejection bar.

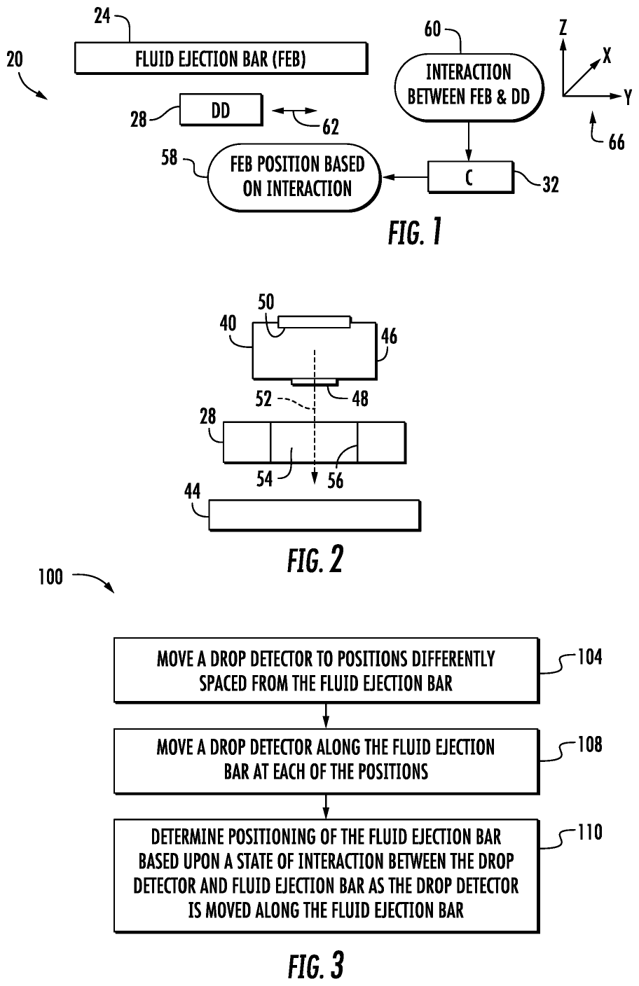

FIG. 1 schematically illustrates an example drop detector calibration system 20. Drop detector calibration system 20 identify the location of the fluid ejection bar for subsequent drop detection monitoring based upon interactions between the fluid ejection bar and the drop detector during movement of the drop detector along the fluid ejection bar. System 20 comprises fluid ejection bar 24, drop detector 28 and controller 32.

Fluid ejection bar 24 comprises a bar or other structure supporting at least one fluid ejection device. Each fluid ejection device comprises components that facilitate the controlled ejection of fluid drops. In one implementation, fluid ejection bar 24 may comprise a single elongate fluid ejection device. In another implementation, fluid ejection bar 24 may comprise an array or series of individual fluid ejection devices in a row or staggered along a length of fluid ejection bar 24. In one implementation, fluid ejection bar 24 is movable along the illustrated Z-axis. In one implementation, fluid ejection bar 24 is stationary along the Z-axis. In one implementation, fluid ejection bar 24 is movable along the X axis to selectively position fluid ejection bar 24 opposite to drop detector 28. In some implementations, fluid ejection bar 24 is movable along the Y-axis, such as when fluid ejection bar 24 is scanned across the medium that is to receive drops ejected by the at least one fluid ejection device of fluid ejection bar 24.

Drop detector 28 comprises a device that senses the ejection of fluid drops by the at least one fluid ejection device of fluid ejection bar 24. In one implementation, drop detector 28 senses the path or trajectory of the drops from fluid ejection bar 24. In one implementation, drop detector 28 may be used to detect the presence or absence of drops ejected from individual orifices of fluid ejection bar 24. In one implementation, drop detector 28 is sized so as to span across a plurality of individual fluid ejection devices such that drop detector 28 may concurrently sense ejected droplets from multiple orifices or nozzles of the fluid ejection devices.

FIG. 2 schematically illustrates an example drop detection. FIG. 2 schematically illustrates an individual fluid ejector 40 of a fluid ejection device of fluid ejection bar 24, a portion of drop detector 28 and a drop receiver before during drop ejection monitoring. As shown by FIG. 2, the individual fluid ejector 40 may comprise a fluid ejection chamber 46, a nozzle or orifice 48 and a fluid actuator 50.

Fluid is supplied to the fluid chamber 46. The fluid actuator 50 is actuated to displace fluid within chamber 46 and forced fluid through orifice 48 in the form of a droplet (schematically illustrated by broken lines). The fluid actuator 50 used to displace fluid through the ejection orifice 48 as part of the fluid ejector 40 may comprise a thermal resistive fluid actuator, a piezo-membrane based actuator, and electrostatic membrane actuator, mechanical/impact driven membrane actuator, a magnetostrictive drive actuator, and electrochemical actuator, and external laser actuators (that form a bubble through boiling with a laser beam), other such microdevices, or any combination thereof.

As further shown by FIG. 2, the ejected droplet 52 passes through a sensing region 54 of drop detector 28. In the example illustrated, drop detector 20 comprises an opening 56 forming the sensing region 54. In one implementation, drop detector 28 comprises an optical detector having an emitter and a detector. The emitter projects light into and across the sensing region while the detector monitors light reflected back by the drops or light that is passed across the sensing region from the emitter. In one implementation, drop detector 28 may utilize infrared light emitting diodes commit an infrared beam which is backscattered back to a detector by fluid drop 52.

The ejected fluid drops used for testing or monitoring our received by receiver 44. In one implementation receiver 44 may comprise a basin. In another implementation, receiver 44 may comprise a structure material that absorbs such drops. For example, in one implementation, receiver 44 may comprise a web of absorbent material.

Referring once again to FIG. 1, controller 32 comprises a device that determines a position 58 of a fluid ejection bar 24 based upon interaction 60 between the fluid ejection bar 24 and drop detector 28 during movement of the drop detector 28 along fluid ejection bar 24, such as in the direction indicated by arrows 62. In one implementation, controller 32 is communicatively connected to a sensor that is independent of fluid ejection bar 24 and drop detector 28 that senses interaction between fluid ejection bar 24 and drop detector 28. In one implementation, controller 32 is communicatively connected to a sensor supported by fluid ejection bar 24 that senses interaction between drop detector 28 and fluid ejection bar 24. In another implementation, controller 32 is communicatively connected to a sensor or probe of drop detector 28 that senses interaction between drop detector 28 and fluid ejection bar 24. In yet another implementation, controller 24 is communicatively connected to a sensor associated with an actuator that drives drop detector 24 in the directions indicated by arrows 62. For example, controller 24 may be connected to a power source that changes its output a power in response to interaction between drop detector 28 and fluid ejection bar 24.

Based upon such detected interaction, controller 32 determines a position of fluid ejection bar 24 in space with respect to a predefined coordinate system 66. The position of fluid ejection bar 24 may be determined by positioning drop detector 28 and fluid ejection bar 24 at various relatives spacings. At each relative spacing, the drop detector 28 is moved along the fluid ejection bar 24 and its interaction or lack thereof with the fluid ejection bar is detected. The calibration system 20 is dimensioned and supported such that a predefined interaction occurs when the drop detector 28 is at a predefined spacing relative to the particular position of the fluid ejection bar 24. Based upon the particular spacing of the fluid ejection bar 24 and the drop detector 28 at which a predefined interaction is detected, the calibration system 20 determines the location or Z-axis coordinate of the fluid ejection bar 24 in the coordinate system. This determined location or Z-axis coordinate of the fluid ejection bar 24 is subsequently utilized to control the spacing of the drop detector 28 from the fluid ejection bar 24 during drop ejection monitoring by the drop detector 28 as discussed above with respect to FIG. 2.

In one implementation, the fluid ejection bar 24 is moved relative to the drop detector 28 between each of the various candidate or test height or Z-axis coordinates where the drop detector 28 is moved along the fluid ejection bar 24 (along the Y-axis) to determine whether the predefined interaction occurs. In another implementation, the drop detector 28 is moved relative to the fluid ejection bar 24 between each of the various candidate spacings where the drop detector 28 is moved along the fluid ejection bar 24 to determine whether the predefined interaction occurs. In one implementation, the drop detector 28 is carried by or supported by a much larger fluid ejection bar servicing unit or station having a fluid absorbent web fluid ejection bar sealing or capping mechanisms and/or other fluid ejection bar servicing features, wherein the much larger fluid ejection bar servicing unit is moved relative to the fluid ejection bar to position the drop detector at each of the candidate or test vertical locations or Z-axis coordinates.

In one implementation, such interaction may be the direct physical contact between the drop detector 28 and the fluid ejection bar 24. In such implementations, each of the drop detector 28 and the fluid ejection bar 24 may comprise horns, projections or structural probes that are dimensioned and supported so as to contact one another when the drop detector 28 and the fluid ejection bar 24 are at a predefined spacing from one another. The height at which such direct contact occurs (the positioning along the X axis) and the known predefined spacing may then indicate the actual location of the fluid ejection bar in the predefined coordinate system 66.

In one implementation, the drop detector 28 is incrementally raised or moved to different vertical height or Z-axis coordinates towards the fluid ejection bar 24 until the drop detector 28 physically engages or contacts the fluid ejection bar 24 during movement of the drop detector 28 along the fluid ejection bar 24 at a given arrows Z-axis coordinate for one or both of the fluid ejection bar 24 and/or drop detector 28. The height or Z-axis value or values at which the drop detector 28 initially contacts the fluid ejection bar may then be used to determine fluid ejection bar location along the Z-axis. For example, if the calibration system is designed such that initial contact or tip-to-tip contact occurs when a selected portion of the drop detector 28 and the lower surface of the fluid ejection bar 24 is spaced by a distance d along the Z-axis, initial contact between the drop detector 28 and the fluid ejection bar 24 at a Z-axis coordinate value of r may then indicate that the lower surface of the fluid ejection bar is at coordinate of r+d along the z-axis. If initial contact between the drop detector and the fluid ejection bar initially occurs at a z-axis coordinate value of s, it may be determined that the lower surface of fluid ejection bar is that coordinate s+d. The determined location of fluid ejection bar 24 along the Z axis of the coordinate system may be subsequently utilized to position the selected portion of the drop detector 28 relative to the lower surface of the fluid ejection bar 24 during drop ejection monitoring by the drop detector 28.

In another implementation, the drop detector 28 may be incrementally lowered or moved away from the fluid ejection bar 24 until the drop detector 28 initially passes or crosses the fluid ejection bar without contacting the fluid ejection bar 24. In such an implementation, height or Z-axis coordinate of drop detector 28 at which the drop detector 28 initially crosses the fluid ejection bar 24 may then be utilized to determine fluid ejection bar location or Z-axis coordinate value with respect to the predefined coordinate system 66. For example, if the calibration system 20 is designed such that contact initially discontinues when a selected portion of the drop detector 28 and the lower surface of the fluid ejection bar 24 are spaced by a distance d along the Z-axis, discontinuance of contact between the drop detector 28 and the fluid ejection bar 24 at a Z-axis coordinate value of r may then indicate that the lower surface of the fluid ejection bar 24 is at coordinate of r+d along the Z-axis. If the discontinuance of contact between the drop detector 28 and the fluid ejection bar 24 initially occurs at a Z-axis coordinate value of s, it may be determined that the lower surface of fluid ejection bar 24 is that coordinate s+d. This determined location of fluid ejection bar 24 along the Z-axis may be specifically utilized to position the selected portion of the drop detector 28 relative to the lower surface of the fluid ejection bar 24 during drop ejection monitoring by the drop detector 28.

In one implementation, such contact between the drop detector 28 and the fluid ejection bar 24 may be sensed by a sensor independent of an actuator utilized to translate the drop detector along the fluid ejection bar. In another implementation, such contact between the drop detector 28 and the fluid ejection bar 24 may be sensed based upon signals from the actuator utilized to translate the drop detector 28 along the fluid ejection bar for. For example, contact between the drop detector 28 and the fluid ejection bar 24 may result in stalling of movement of the fluid ejection bar 24. Such stalling may be detected. Contact between the drop detector 28 and the fluid ejection bar 24 may additionally or alternatively result in pulse width modulation change at a servo motor serving as the actuator that moves drop detector 28 along the Y axis, wherein change may indicate such contact or where the change indicates a discontinuance of such contact.

In yet other implementations, the determination that the drop detector 28 is at a predefined spacing relative to the actual positioning of the fluid ejection bar 24 may be indicated by indirect non-contact interaction between the drop detector in the fluid ejector. For example, in one implementation, one of the drop detector 28 and the fluid ejection bar 24 may comprise a light emitter-detector pair while the other of the drop detector 28 and the fluid ejection bar 24 comprises a projection or probe that interrupts a light beam between the emitter-detector pair when the drop detector 28 is moved along the fluid ejection bar 24 along the Y axis at a particular Z-axis value.

FIG. 3 is a flow diagram of an example drop detector calibration method 100. For purposes of discussion, method 100 described as being carried out by one implementation of drop detector calibration system 20. It should be appreciative that method 100 may be likewise carried out with any of the drop detector calibration system described or by similar drop detector calibration systems.

As indicated by block 104, drop detector 28 is moved to various candidate vertical height or candidate Z-axis coordinates in the predefined coordinate system 66. As indicated by block 108, at each of the different vertical height or candidate Z-axis coordinates, drop detector 28 is moved along fluid ejection bar 24, along the Y axis. In one implementation, drop detector 28 is moved in a direction parallel to the longitudinal axis of fluid ejection bar 24. In one implementation, such movement of drop detector 28 is horizontal.

As indicated by block 112, controller 32 determines a location of the fluid ejection bar 24 along the Z axis of the predefined coordinate system based upon a state of interaction between drop detector 28 and fluid ejection bar 24 as the drop detector 28 is moved along the fluid ejection bar 24. In other words, at each position or candidate Z-axis coordinate, controller 32 determines whether drop detector 28 and fluid ejection bar 24 have satisfied a predetermined interaction threshold. The predetermined interaction threshold may be sufficient physical contact between drop detector 28 and fluid ejection bar 24 such that the actuator driving drop detector 28 stalls which resulted in signals being transmitted to controller 32. As discussed above, the type of interaction in the manner in which it is sensed may vary. The interaction may be a direct physical contact or may be an indirect non-physical contact such as with a light emitter-detector sensing pair.

If the predetermined interaction threshold is not satisfied, controller 32 may output control signals repositioning drop detector 28 at a different Z-axis coordinate, where drop detector 28 is once again moved along fluid ejection bar 24 and a determination is made whether the interaction threshold is satisfied at this Z-axis coordinate. This process repeats until drop detector 28 is positioned at a Z-axis coordinate that results in the predetermined interaction threshold being satisfied.

Once the Z-axis coordinate at which the drop detector 28 sufficiently interacts with fluid ejection bar 24 during movement of drop generator 28 along fluid ejection bar 24 has been found, controller 32 then utilizes the found Z-axis coordinate and the predetermined spacing of drop generator 28 and fluid ejection bar 24 at which such interaction threshold is to be satisfied to determine the location of the fluid ejection bar 24 along the Z-axis of the predefined coordinate system 66. For example, if the calibration system is designed such that initial contact or tip-to-tip contact occurs when a selected portion of the drop detector 28 and the lower surface of the fluid ejection bar 24 is spaced by a distance d along the Z-axis, initial contact between the drop detector 28 and the fluid ejection bar 24 at a Z-axis coordinate value of r may then indicate that the lower surface of the fluid ejection bar is at a coordinate of r+d along the Z-axis. As discussed above, positioning of the drop detector at the various candidate Z-axis coordinates may occur in a height incrementing fashion where drop detector 20 is incrementally moved towards fluid ejection bar 24 or in a height decrementing fashion where drop detector 20 is incrementally moved away from fluid ejection bar 24.

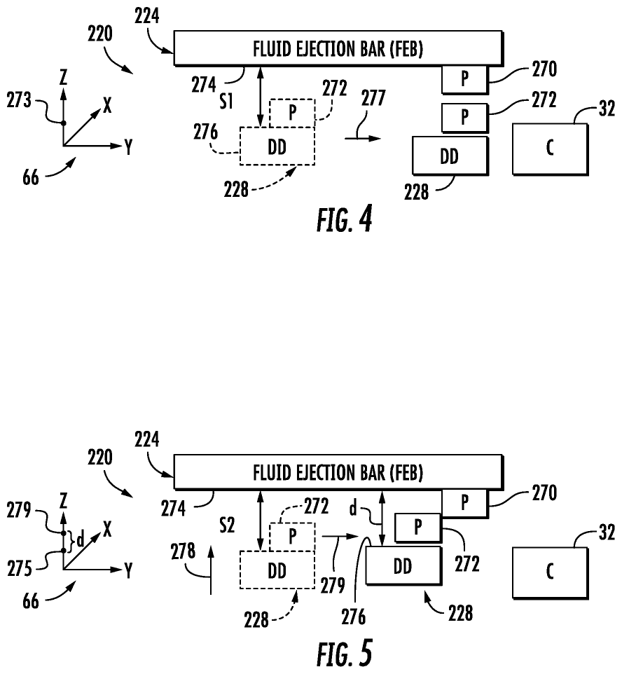

FIGS. 4 and 5 illustrate an example of method 100 being carried out by an example calibration system 220. Calibration system 220 is similar to calibration system 20 described above except that calibration system 220 is illustrated as specifically comprising fluid ejection bar 224 and drop detector 228. Fluid ejection bar 224 is similar to fluid ejection bar 224 except that fluid ejection bar 224 is specifically illustrated as comprising a probe 270. Drop detector 228 is similar to drop detector 28 except that drop detector 228 is specifically illustrated as comprising a fluid ejection bar probe 272. Probe 270 comprises a tab, horn or other protuberance projecting from a lower surface of fluid ejection bar 224 towards drop detector 228 in the z-axis. Probe 272 comprises a tab, horn or other protuberance projecting from an upper surface of drop detector 228 towards fluid ejection bar 224 in the z-axis. Probes 270 and 272 are located so as to interact with one another through direct physical contact during movement of drop detector 228 along fluid ejection bar 224 when the fluid ejecting plane 274 of fluid ejection bar 224 is spaced from the drop detecting plane 276 of drop detector 228 by a distance d.

FIG. 4 illustrates drop detector 228 (shown in broken lines) initially located at a first candidate position or Z-axis coordinate 273 where planes 274 and 276 are separated by a spacing S1. As indicated by arrow 277, drop detector 228 is moved along fluid ejection bar 124. As shown by solid lines, such movement does not result in probe 272 interacting with or physically contacting probe 270. As a result, drop detector 28 is moved to a different candidate Z-axis coordinates.

FIG. 5 illustrates drop detector 228 (shown in broken lines) after drop detector 228 has been raised in the direction indicated by arrow 278 to a second greater candidate position or Z-axis coordinate 275 where planes 274 and 276 are separated by spacing S2 which is less than the predefined distance d. As indicated by arrow 279, drop detector 228 is moved along fluid ejection bar 124. As shown by solid lines, such movement results in probe 272 interacting with or physically contacting probe 270. Upon identifying such interaction, controller 32 determines the positioning of plane 274 based upon the candidate Z-axis coordinate value 275 at which such interaction occurred and the predetermined spacing d at which such interaction occurs. Controller 32 may determine that the Z-axis coordinate of plane 274 is the candidate Z-axis coordinate value 275 plus the distance d, Z-axis coordinate 279. The determined Z-axis coordinate 279 of plane 274 may be specifically utilized to position planes 274 and 276 during drop ejection monitoring by drop detector 228.

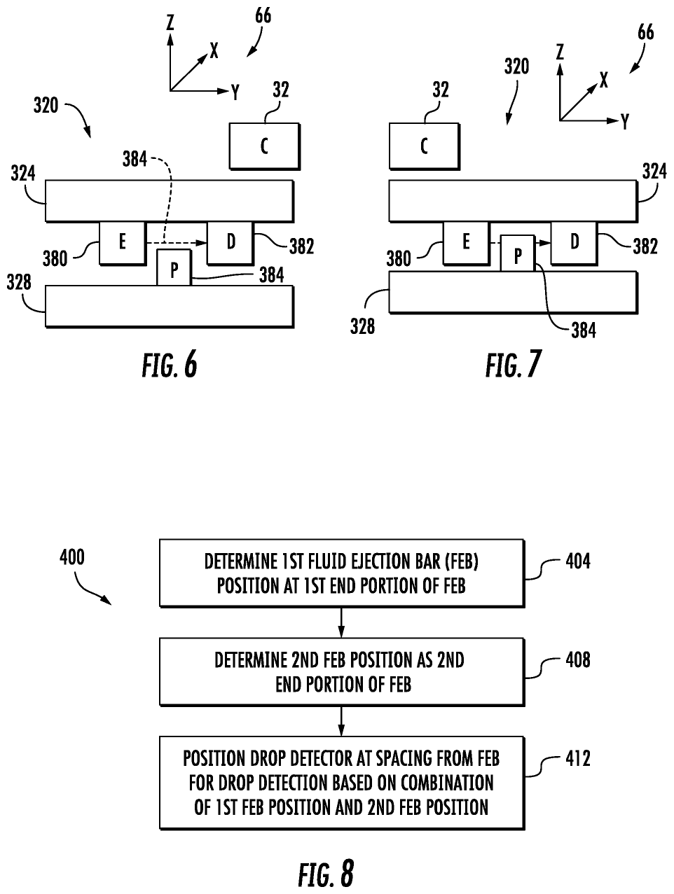

FIGS. 6 and 7 schematically illustrate drop detector calibration system 320. Calibration system 320 is similar to calibration systems 20 and 220 described above except that calibration system 320 utilizes indirect or non-contact physical interaction between a fluid ejection bar 324 and a drop detector 3282 identify the actual position or Z-axis coordinate of each of various portions of fluid ejection bar 324. As shown by FIG. 6, fluid ejection bar comprises an emitter-detector pair having an optical emitter 380 and an optical detector 382. Drop detector 328 comprises a tab, protuberance, flag probe 384 size and located so as to interrupt light 386 emitted by emitter 380 and detected by detector 382 when drop detector 328 is sufficiently close to fluid ejection bar 324.

FIG. 6 illustrates drop detector 328 at a first candidate Z-axis coordinate during movement of drop generator 328 along fluid ejection bar 324, along the Y-axis. As shown by 6, such movement does not satisfy an interaction threshold in that probe 384 does not interrupt detection of light 384 by detector 382. As a result, drop detector 328 will be moved to a different candidate Z-axis coordinate.

FIG. 7 illustrates drop detector 328 after it has been repositioned to a second candidate Z-axis coordinate. At the second candidate Z-axis coordinate, drop detector 328 is sufficiently close to fluid ejection bar 324 such that probe 384 interferes with the reception of light 384 by detector 382. Such interference is detected by controller 32 which then determines the positioning of fluid ejection bar 324 in the Z-axis of the coordinate system 66 based upon the value of the second candidate Z-axis coordinate and the predetermined or default spacing at which probe 384 is designed to initially interfere or initially stop interfering with the detection of light 384 by detector 382.

In some fluid ejection systems, the fluid ejection bar may be slightly tilted or canted with respect to the z-axis (not really perpendicular to the z-axis). This may result in one end of the fluid ejection bar having a different height along the z-axis as compared to the other end of the fluid ejection bar. This may result in the fluid ejection bar 24 having different heights or coordinate values along the z-axis along its length. FIG. 8 is a flow diagram of an example drop detector calibration method 400 for determining the actual positioning of various portions of a tilted fluid ejection bar in a coordinate system to facilitate subsequent drop detection monitoring along each of the various portions of the tilted fluid ejection bar.

As indicated by block 404, the Z-axis coordinate of a first end of fluid ejection bar 24, 224, 324 may be determined as described above. As indicated by block 408, a second fluid ejection bar Z-axis location at a second end of the fluid ejection bar is determined as described above.

As indicated by block 412, when monitoring or evaluating drop ejection performance at a location between the first end and the second end of the fluid ejection bar, the drop detector is positioned at a spacing from the fluid ejection bar based upon a combination of the first determined fluid ejection bar Z-axis location and the second determined fluid ejection bar Z-axis location. For example, in response to the first end of the fluid ejection bar having a Z-axis coordinate value of a and the second end of the fluid ejection bar having a Z-axis coordinate value of b, when monitoring drop ejection performance at a location along the fluid ejection bar equidistantly spaced from the first and the second end, drop detector 28 may be located at a Z-axis coordinate value of (a+b)/2. By way of another example, in a system where the first end has the Y-axis coordinate value of A and a z-axis coordinate value of a and wherein the second and has a Y-axis coordinate value of B and a z-axis coordinate value of b, drop rejected 28 may be located at a z-axis coordinate of (a+b)/3 when monitoring drop ejection performance at a Y-axis coordinate of (A+B)/3.

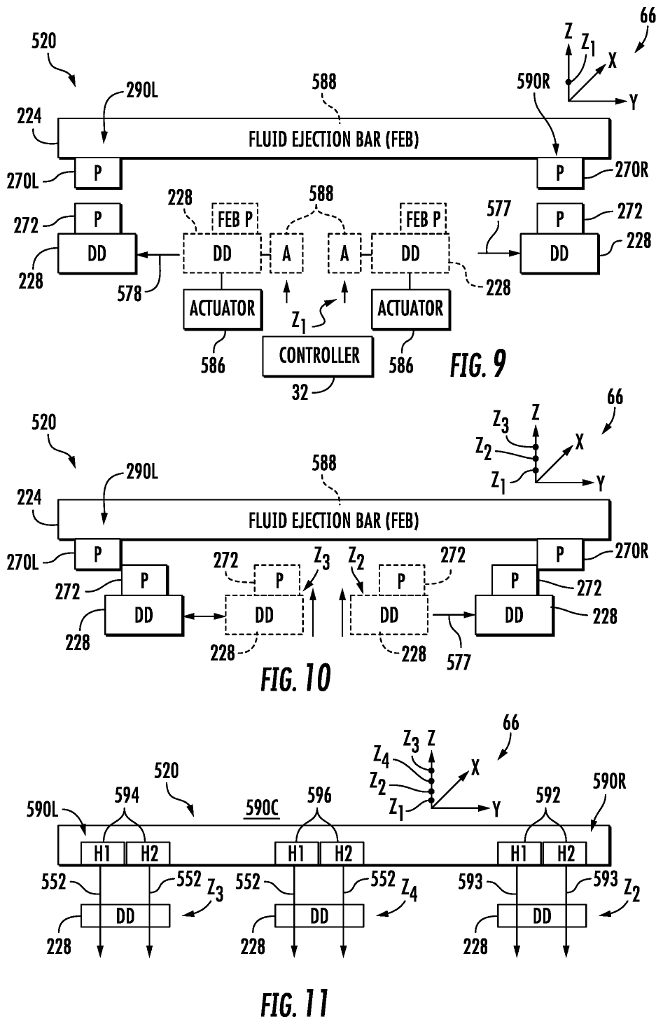

FIGS. 9-11 illustrate an example drop detector calibration system 520 carrying out method 400. Drop detector calibration system 520 is similar to drop detector calibration system 220 described above except that system 520 additionally illustrates the actuators utilized to (a) raise and lower drop detector 228 along the Z-axis and (b) translate or otherwise move drop generator 228 along the Y-axis. Fluid ejection bar 224 comprises a probe at each of its opposite end portions, a probe 270R on a first end and a probe 270L on a second opposite end. Those remaining components of drop detector calibration system 520 which correspond to components of drop detector calibration system 220 are numbered similarly.

As shown by FIG. 9, system 520 comprises actuator 586 for controllably locating drop detector 228 along the Z-axis coordinate system 66. In one implementation, actuator 586 comprises an eccentric cam or multiple eccentric cams which upon being controllably rotated to different angular positions raise and lower drop detector 228 along the Z-axis. In other implementations, other linear actuators may be utilized to move drop detector 228 along the Z-axis. In some implementations, actuator 586 raises and lowers a fluid ejection bar servicing unit which itself supports and carries drop detector 228, along the Z-axis.

As further shown by FIG. 9, system 520 additionally comprises actuator 588. Actuator 588 moves drop detector 228 along fluid ejection bar 224, along the Y-axis of coordinate system 66. In one implementation, actuator 580 comprises a continuous belt or loop carrying drop detector 228, wherein the loop is driven to reposition drop detector 228 along the Y-axis. In other implementations, actuator 580 may comprise other linear actuators for linearly translating drop detector 228 along the Y-axis of coordinate system 66.

FIGS. 9 and 10 illustrate drop detector calibration system 520 during its determination of the positions (Z-axis coordinates) of two distinct portions of fluid ejection bar 224, such as to ends of fluid ejection bar 224. FIG. 10 illustrates the positioning of drop detector 228 at different Z-axis coordinate positions during the monitoring of drop ejection from different portions of the fluid ejection bar 224 based upon the determined Z-axis coordinates of the two different portions of fluid ejection bar 224.

FIG. 9 schematically illustrates calibration system 520 with actuator 586 and 588 positioning drop detector 228 near opposite end portions of a tilted fluid ejection bar 224 for calibrating or determining the position (Z-axis or vertical axis position) in coordinate system 66. FIG. 9 illustrates actuator 586 locating drop detector 228 (shown in broken lines) at a first vertical height or Z-axis coordinate Z1. As indicated by arrow 577, FIG. 9 further illustrates the same drop detector 228 (shown in broken lines) after drop detector 228 has been moved along fluid ejection bar 224 (along the Y-axis) towards probe 270R located at a first end portion 590 of fluid ejection bar 224. In the example illustrated, such movement does not result in interaction, direct physical contact between probe 272 of drop detector 228 and probe 270R of fluid ejection bar 224.

FIG. 9 illustrates the same operation at the opposite end of fluid ejection bar 224. In particular, FIG. 9 illustrates actuator 586 locating drop detector 228 (shown in broken lines) at the vertical height or Z-axis coordinate Z1. As indicated by arrow 578, FIG. 9 further illustrates the same drop detector 228 (shown in broken lines) after drop detector 228 has been moved along fluid ejection bar 224 towards probe 270L (along the Y-axis) located at a second end portion 590L of fluid ejection bar 224. In the example illustrated, such movement does not result in interaction, direct physical contact between probe 272 of drop detector 228 and probe 270L of fluid ejection bar 224. As a result, controller 32 outputs control signals causing actuator 586 to vertically position drop detector 228 at additional candidate Z-axis positions, wherein controller 588 moves drop detector 228 along the Y-axis at each of the different Z-axis positions to determine if probe 272 interacts with probe 270R at first and portion 590R or if probe 27 to interact with probe 270L and end portion 590L.

FIG. 10 illustrates drop detector 228 at a Z-axis coordinate Z2 proximate end portion 590R and at a different Z-axis coordinate Z3 proximate end portion 590L. Following the “miss” by probe 272 at Z-axis coordinate Z1 at and portion 590R (shown in FIG. 9), the process of moving probe 272 of drop detector 228 to one side of probe 270R, incrementally raising drop detector 2282 a new greater Z-axis coordinate and once again moving drop detector 228 along fluid ejection bar 224 (along the Y axis) is repeated until drop detector 228 is at a sufficiently high Z-axis coordinate value such that probe 272 interacts or contact probe 270R. The height or Z-axis coordinate Z2 shown in FIG. 10 is where probe 272 initially contacted probe 270R after such repeated attempts to identify the Z-axis coordinate where probe 272 would initially contact probe 270R. Likewise, the height or Z-axis coordinate Z3 shown in FIG. 10 is where probe 272 initially contacted probe 270L after such repeated attempts to identify the Z-axis coordinate where probe 272 would initially contact probe 270L.

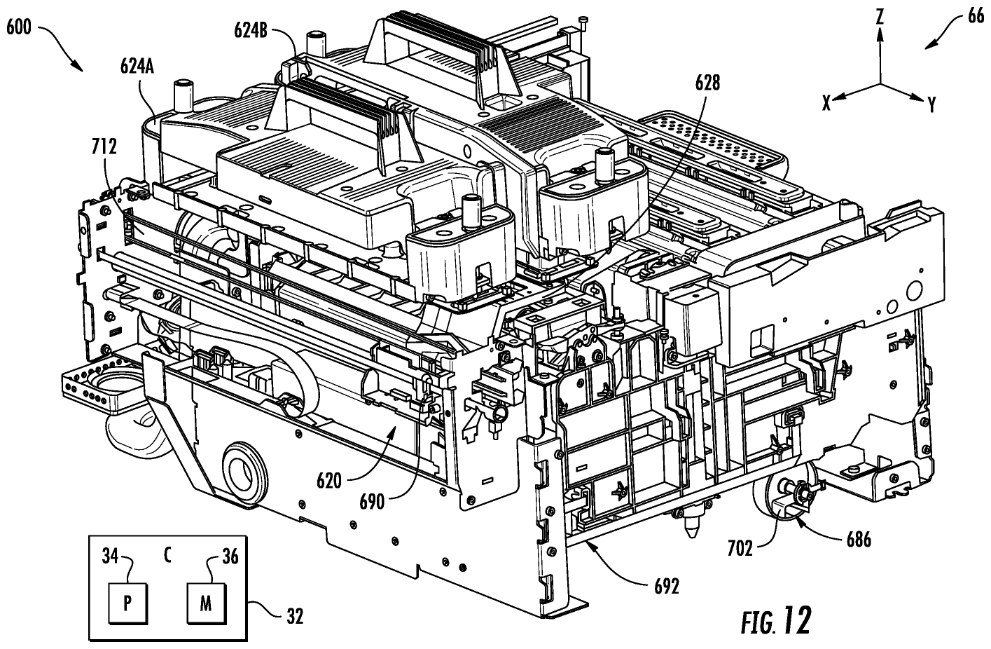

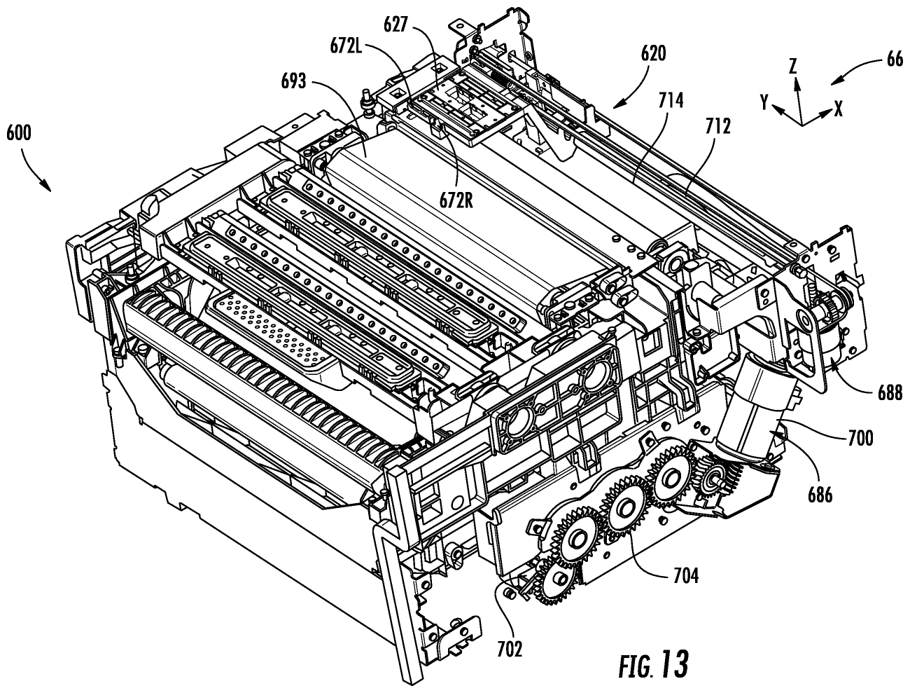

As shown by FIG. 9, the Z-axis coordinate Z3 is greater than the Z-axis coordinate Z2 due to the downward tilting of fluid ejection bar 224 from end portion 590L towards and portion 590R. As a result, the same portions of fluid ejection bar 224 will have different Z-axis coordinates depending upon their proximity to either of the two end portions 590R and 590L. By determining such different Z-axis coordinates, calibration system 520 addresses the tilt to provide enhanced drop ejection monitoring by drop detector 228 as shown in FIG. 11.

FIG. 11 illustrates drop detector 228 monitoring different portions of fluid ejection bar 224 at different times based upon the determined vertical positioning or Z-axis coordinates of end portions 590R and 590L. In the example illustrated, drop detector 228 has a sufficient length (along the Y axis) so as to concurrently span two different fluid ejection devices or heads H1 and H2. As shown on the right side of fluid ejection bar 224, controller 32 (shown in FIG. 9) outputs control signals to actuator 586 and actuator 588 to position drop detector 228 opposite to fluid ejection devices 592 at end portion 590R and ata height or Z-axis coordinate based upon the Z-axis coordinate Z2 identified in FIG. 10. At such height, drop detector 228 receives and senses fluid drops 552 ejected by fluid ejection devices 592. In one implementation, drop detector 228 is positioned at the Z-axis coordinate Z2.

As shown on the left side of fluid ejection bar 224, and at a different time, controller 32 outputs control signals causing actuators 586 and 588 to position drop detector 228 opposite to fluid ejection devices 594 at end portion 590L and at a height or Z-axis coordinate based upon the Z-axis coordinate Z3 identified in FIG. 10. In one implementation, drop detector 228 is positioned at the Z-axis coordinate Z3. At such height, drop detector 228 receives and senses fluid drops 552 ejected by fluid ejection devices 594.

As shown in the central portion of fluid ejection bar 224, and at a different time, controller 32 outputs control signals causing actuators 586 and 588 to position drop detector 228 opposite to fluid ejection devices 596 at central portion 590C and at a height or Z-axis coordinate based upon a combination of the Z-axis coordinates Z2 and Z3 identified in FIG. 10. In one implementation, drop detector 228 is positioned at the Z-axis coordinate Z4. In one implementation, the Z-axis coordinate Z4 four portion 590C is determined by linearly interpolating the determined Z-axis coordinate values at the end portions 590R and 590L. For example, in response to end portion 590R of the fluid ejection bar having a determined Z-axis coordinate value of a and end portion 590L of the fluid ejection bar having a determined Z-axis coordinate value of b, when monitoring drop ejection performance at portion 590C equidistantly spaced from end portions 590R, 590L, drop detector 228 may be located at a Z-axis coordinate value of (a+b)/2. At such height, drop detector 228 receives and senses fluid drops 552 ejected by fluid ejection devices 596.

FIGS. 12-17 illustrate an example fluid ejection system 600 having an example drop detector calibration system 620. In one implementation, fluid ejection system 600 comprises a three-dimensional printer. In another implementation, fluid ejection system 600 may comprise the two-dimensional printer. Drop detector calibration system 620 may operate in a fashion similar to drop detector calibration systems 20, 220 and 520 above carrying out methods 100 and 400 described above. Drop detector calibration system 620 comprises the fluid ejection bars 624A, 624B (collectively referred to as fluid ejection bar 624), drop detector 628, actuator 686, actuator 688 and controller 32 (schematically shown).

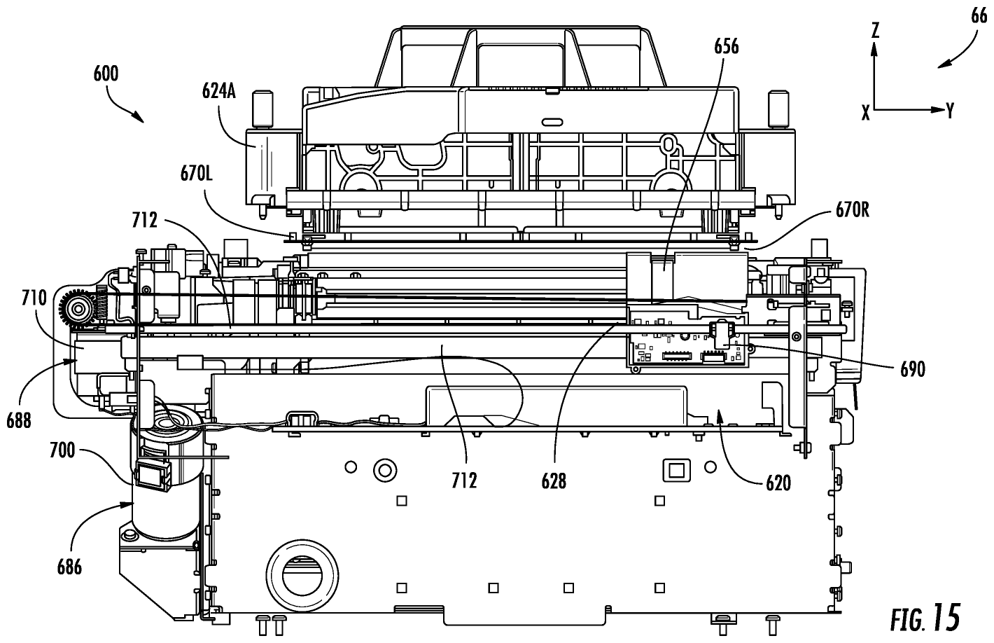

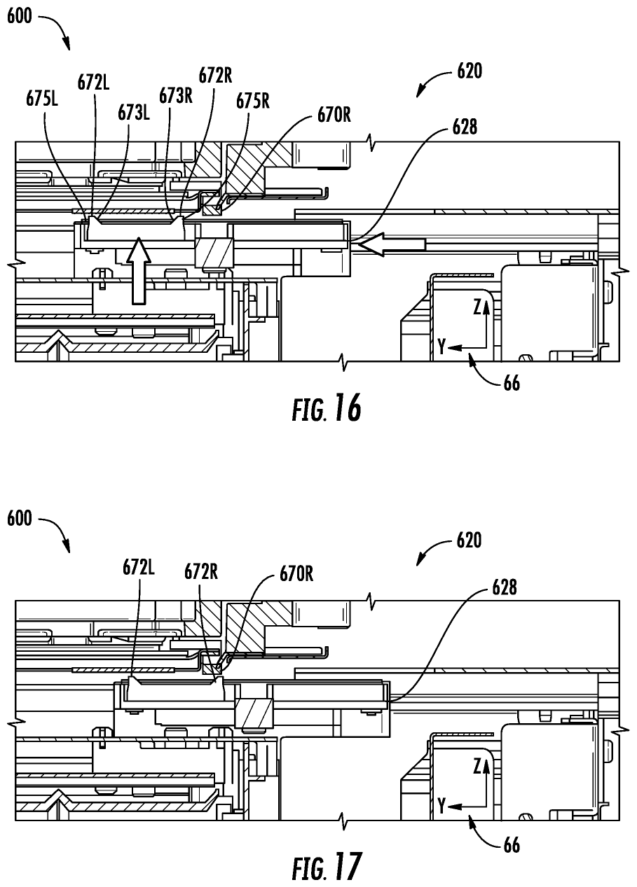

Fluid ejection bar 624 are similar to fluid ejection bar 224 described above. Each of fluid ejection bar 624 comprises multiple fluid ejection devices having fluid ejectors similar to that described above with respect to FIG. 2. As shown by FIGS. 15 and 16, the opposite ends of each of fluid ejection bar 624 comprises a downwardly projecting or suspended probe 670. Probe 670 comprises a projection downwardly extending in the Z-axis. Each of the surfaces or components of fluid ejection bar 624 may have a predefined dimensional and positional relationship with respect to each of its respective left and right probes.

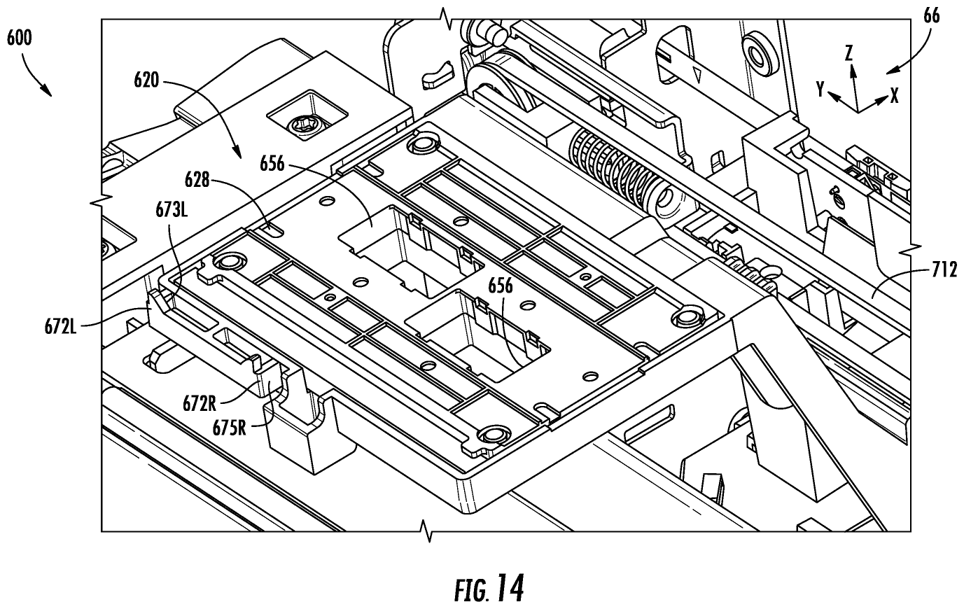

Drop detector 628 is similar to drop detector 228 described above. Drop detector 628 comprises a platform and drop detection. As shown by FIG. 14, drop detector 628 comprises a pair of openings 656 corresponding to a pair of consecutive staggered fluid ejection devices of fluid ejection bars 624. Openings 656 form sensing regions or zones through which ejected dropped pass and are sensed before falling to a receiver, a drop absorbent web supported below opening 656. In one implementation, drop detector 628 comprises an optical detector having an emitter and a detector. The emitter projects light into and across the sensing region while the detector monitors light reflected back by the drops or light that is passed across the sensing region from the emitter. In one implementation, drop detector 628 may utilize infrared light emitting diodes commit an infrared beam which is backscattered back to a detector by a fluid drop.

As further shown by FIGS. 14, 16 and 17, drop detector 628 additionally comprises probes 672R and 672L (collectively referred to as probe 672). Probes 672 comprise upright projections or flag features that are molded onto the platform or carriage of drop detector 628. Probe 672 are dimensioned so as to contact and engage probe 670 of fluid ejection bars 624 when drop detector 628 is at a predefined spacing or distance from a fluid ejection bars 624 along the Z-axis of the coordinate system 66. Each of the surfaces of drop detector 628 may have a predefined dimensional and positional relationship with respect to probes 672.

In the example illustrated, probe 672 have mutually facing ramped surfaces 673R and 673L (collectively referred to as ramped surfaces 673) and opposing engagement surfaces 675R and 675L (collectively referred to as engagement surfaces 675). Ramped surface 673R facilitates movement of probe 672R in the leftward direction past the probe 670 on the right side (as seen in FIGS. 15-17) of a fluid ejection bar 624. Likewise, ramped surface 673L facilitates movement of probe 672L in the rightward direction past the probe 670 on the left side of a fluid ejector bar 624. In contrast, engagement surfaces 675 provide a distinct and more robust engagement with probes 670.

Actuator 686 vertically raises or moves drop detector 628 in a controlled fashion along the Z-axis between different Z-axis coordinates. In the example illustrated, actuator 686 moves a fluid ejection bar service unit 692 which not only vertically supports and carries drop detector 628, but which also comprises a fluid absorbent web 693 (shown in FIG. 13) for servicing fluid ejection bar 624. As shown by FIG. 13, in the example implementation, actuator 686 comprises a motor 700 that transmits torque to at least one eccentric cam 702 through an intermediate gear train 704. In the example illustrated, actuator 686 comprises a pair of eccentric cams 702 (shown in FIGS. 12 and 13) connected by an intervening rod or shaft (not shown). Controlled rotation of the eccentric cams 702 moves the service unit 692 and the supported drop detector 628 between various vertical height or Z-axis coordinates.

Actuator 688 moves drop detector 628 along fluid ejection bar 624, in directions along the Y-axis. Actuator 688 moves drop detector 628 in the Y-axis relative to the underlying and supporting service unit 692. In the example illustrated, actuator 688 comprises a cable or belt drive having a rotary actuator 710, such as a servo motor, that drives a continuous endless cable or belt loop 712 which is affixed to drop detector 628 in which passed through an encoder 690. Movement of the continuous endless cable or belt loop moves drop detector 628 along a guide rod 714 (shown in FIG. 13) along the Y-axis. In other implementations, actuator 688 may comprise other devices to linearly translate drop detector 628 along the Y-axis.

Controller 32 comprises a processing unit 34 that follows instructions contained in a non-transitory computer-readable medium or memory 36 so as to carry out methods 100 and 400 described above. Controller 32 outputs control signals which are communicated to motor 700 and 710 to control actuators 686 and 688. In the example illustrated, controller 32 may further output control signals to a separate actuator which selectively positions one of fluid ejection bar 624 generally opposite to drop detector 628.

In one implementation, controller 32 determines the Z-axis location or coordinates of a fluid ejection bar 624 pursuant to the following sequence:

1. The service station unit 692 and supported drop detector 628 are lowered to the first Z-calibration edge detect start position.

2. One of fluid ejection bar 624 is moved over the drop detector 628.

3. The drop detector 628 is vertically raised along the Z-axis to a starting height or Z-axis coordinate.

4. The drop detector 628 is moved in the Y-direction, wherein a determination is made as to whether one of probe 670 is interacting with one of probes 672. Controller 32 attempts to find the bottom edge of probe 670 by detecting a small change in the pulse width modulation (PWM) of the motor servo 688.

5. If the servo motor 688 does not undergo an expected stall on the lead-in ramp 673, the drop detector 628 is returned to the edge-detect start position and the cams 702 are rotated at less than 20° increments, such as in increments of less than 10° and nominally 6° which advances the drop detector 628 up to the next edge-detect height or candidate Z-axis coordinate.

6. The edge-detect process repeats until probe 670 contacts probe 672 and a stall is triggered. This height or Z-axis at which such contact occurred is then stored. In one implementation, the height or determined Z-axis coordinate is stored on the printer's formatter board.

The process is repeated with respect to each of the probe 670 of each of the fluid ejection bar 674 to determine a Z-calibration for both end portions of each of the fluid ejection bar 624.

FIGS. 16 and 17 illustrate the use of probes 670R and 672R to determine the Z-axis coordinate location of fluid ejection bar 624. FIG. 16 illustrates the positioning of drop detector 628 along the Z-axis system 66 at a Z-axis coordinate by actuator 686. FIG. 17 illustrates the movement of drop detector 628 along the Y-axis of system 66 while drop detector 628 is at the Z-axis coordinate. As shown in FIG. 17, at the particular Z-axis coordinate shown, probe 672R interacts with, directly physically contacts, probe 670R. this may result in stalling which is ejected by controller 32. Based upon the particular Z-axis coordinate at which such interaction was detected, controller 32 may determine the Z-axis coordinate of probe 670R and the Z-axis coordinate value or location for any of the surfaces of the fluid ejection bar 624 associated with the probe 670R. Controller 32 may specifically utilize the various determined Z-axis coordinate values precisely locate drop detector 628 relative to one of fluid ejection bars 624 during drop ejection monitoring by drop detector 628. The Z-axis coordinate information may also be used for other operations which may involve the positioning of components relative to either of the fluid ejection bars 624.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A drop detector calibration system comprising:
a fluid ejection bar;
a drop detector movable along the fluid ejection bar at different spacings from the fluid ejection bar;
a controller to determine a vertical location of the fluid ejection bar based upon interaction between the fluid ejection bar and the drop detector during movement of the drop detector along the fluid ejection bar.

2. The drop detector calibration system of claim 1, wherein the controller is to position the drop detector relative to the ejection bar for sensing in flight drops ejected by the fluid ejection bar based upon the determined location of the fluid ejection bar.

3. The drop detector calibration system of claim 2, wherein the fluid ejection bar comprises a drop detector probe and wherein the drop detector comprises a fluid ejection bar probe, the drop detector calibration system further comprising:
a first actuator to move the fluid ejection bar probe along the fluid ejection bar;
a second actuator to move the fluid ejection bar probe towards and away from the fluid ejection bar, wherein the controller is to determine the location of the fluid ejection bar based upon interaction between the fluid ejection bar probe and the drop detector probe.

4. The drop detector calibration system of claim 3, wherein the drop detector probe is supported by the fluid ejection bar at a first end portion of the fluid ejection bar, the system further comprising a second drop detector probe supported by the fluid ejection bar at a second end portion of the fluid ejection bar, wherein the controller is to determine a first location of the first end portion of the ejection bar based upon interaction between the fluid ejection bar probe and the drop detector probe and wherein the controller is to determine a second location of the second end portion of the ejection bar based upon interaction between the fluid ejection bar probe and the second drop detector probe.

5. The drop detector calibration system of claim 4, wherein the fluid ejection bar probe comprises a first projection for interacting with the drop detector probe and a second projection for interacting with the second drop detector probe.

6. The drop detector calibration system of claim 4, wherein the controller is to position the drop detector between the first end portion and the second end portion, at a spacing from the fluid ejection bar based upon a combination of the first location in the second location.

7. The drop detector calibration system of claim 3, wherein the interaction between the fluid ejection bar probe and the drop detector probe comprises physical engagement between the fluid ejection bar probe in the drop detector probe.

8. The drop detector calibration system of claim 3, wherein the interaction between the fluid ejection bar probe in the drop detector probe is non-contact interaction.

9. The drop detector calibration system of claim 3 further comprising a fluid receiver to receive drops ejected by the fluid ejector, wherein the second actuator is to move the fluid receiver, the drop detector and the fluid ejection bar probe towards and away from the fluid ejection bar.

10. The drop detector calibration system of claim 3, wherein the fluid ejection bar comprises a series of fluid ejection dies and wherein the drop detector has a length of at least two of the fluid ejection dies.

11. A method for calibrating a drop detector with respect to a fluid ejection bar, the method comprising:
moving a drop detector to different vertical heights;
moving the drop detector along the fluid ejection bar at each of the different vertical heights;
and
determining a location of the fluid ejection bar based upon a state of interaction between the drop detector and fluid ejection bar as the drop detector is moved along the fluid ejection bar at each of the different vertical heights.

12. The method of claim 11, wherein the state of interaction comprises a state of physical engagement between the drop detector and the fluid ejection bar.

13. The method of claim 12, wherein the state of physical engagement between the drop detector in the fluid ejection bar comprise a state of physical engagement between the suspended projection extending from the fluid ejection bar and an upright projection extending from the drop detector.

14. The method of claim 13, wherein the state of physical engagement is determined based upon stalling of movement of the upright projection as the drop detector is moved along the fluid ejection bar.

15. A non-transitory computer-readable medium containing drop detector calibration instructions to direct a processing unit to:
output signals to move a drop detector to different locations along a an axis of a coordinate system;
output signals to move the drop detector along the fluid ejection bar at each of the different locations; and
determine a location of the fluid ejection bar along the first axis of the coordinate system based upon a state of interaction between the drop detector and fluid ejection bar as the drop detector is moved along the fluid ejection bar.
